(19) United States
(12) Patent Application Publication
(10) Pub. No.: US 2013/0094586 A1
(43) Pub. Date: Apr. 18, 2013

(54) Direct Memory Access With On-The-Fly Generation of Frame Information For Unrestricted Motion Vectors

(71) Applicants: Amichay Amitay, Hod Hasharon (IL); Alexander Rabinovitch, Kfar Yona (IL); Leonid Dubrovin, Karney Shomron (IL)

(72) Inventors: Amichay Amitay, Hod Hasharon (IL); Alexander Rabinovitch, Kfar Yona (IL); Leonid Dubrovin, Karney Shomron (IL)

(73) Assignee: LSI Corporation, Milpitas, CA (US)

(21) Appl. No.: 13/274,422

(22) Filed: Oct. 17, 2011

(51) Int. Cl. H04N 7/32

(52) U.S. Cl. 375/240.16; 375/E07.125; 375/E07.243

(57) ABSTRACT

A method for performing motion estimation based on at least a first VOP stored in a memory includes the steps of: receiving a request to read a data block indicative of at least a portion of the first VOP for predicting a second VOP that is temporally adjacent to the first VOP; utilizing a DMA module for determining whether the data block is a UMV block; translating a block address for retrieving at least a portion of the data block from the memory as a function of one or more parameters generated by the DMA module; and generating a complete data block as a function of the portion of the data block retrieved from the memory and the one or more parameters generated by the DMA module.

### FIELD OF THE INVENTION

The present invention relates generally to electronic circuits, and more particularly relates to video compression techniques.

### BACKGROUND OF THE INVENTION

In the context of video compression, block-based algorithms, such as, for example, a block matching algorithm (BMA), are widely used for exploiting video temporal redundancy among adjacent digital video frames, also referred to herein as video object planes (VOPs), within a sequence of video frames for the purpose of motion estimation and efficient coding. Motion estimation, which is often considered one of the most computationally demanding aspects of a video coding methodology (e.g., Moving Picture Experts Group (MPEG)-4 standard), generally involves selecting a given video frame as a reference frame and then predicting subsequent frames based on the reference frame. In essence, the purpose of a BMA is to locate a matching block from a VOP i, that may be a reference VOP, in some other VOP j, which may appear before or after i. This can be used to discover temporal redundancy in the video sequence, thereby increasing the effectiveness of interframe video coding.

An Unrestricted Motion Vector (UMV) tool allows motion vectors to point outside the boundary of the reference VOP. Edge pixels or “pels” are used as a prediction for nonexistent (i.e., to be determined) pels in a subsequent VOP. In UMV mode, a significant gain is achieved if there is movement along the edge of the pictures, especially for smaller picture formats. Additionally, this mode includes an extension of the motion vector range so that larger motion vectors can be used. UMV mode can improve motion compensation efficiency, especially when there are objects moving into and out of a given frame.

Out-of-bound motion vectors are supported in state-of-the-art video compression standards and algorithms (e.g., advanced video coding (AVC) and scalable video coding (SVC), among others). However, known methodologies for detecting UMVs generally require complex software and additional processing cycles. Furthermore, redundant memory bandwidth is required to perform the inefficient reads associated with UMV. Consequently, conventional methodologies for performing video coding are often inefficient and/or undesirable.

### SUMMARY OF THE INVENTION

Embodiments of the present invention address the above-identified need by providing an efficient means of performing video coding. By utilizing direct memory access (DMA) to detect UMV transfers, techniques of the invention beneficially simplify the treatment of motion vectors, reduce the cycle count of DMA transfers, and reduce memory bandwidth, among other advantages.

In accordance with an aspect of the invention, a method for performing motion estimation based on at least a first VOP stored in a memory includes the steps of: receiving a request to read a data block indicative of at least a portion of the first VOP for predicting a second VOP that is temporally adjacent to the first VOP; utilizing a DMA module for determining whether the data block is a UMV block; translating a block address for retrieving at least a portion of the data block from the memory as a function of one or more parameters generated by the DMA module; and generating a complete data block as a function of the portion of the data block retrieved from the memory and the one or more parameters generated by the DMA module.

In accordance with another aspect of the invention, an apparatus for performing motion estimation based on at least a first VOP includes memory adapted to store at least the first VOP and a DMA module coupled with the memory. The apparatus further includes at least one processor coupled with the DMA module. The processor is operative to generate a request to read a data block indicative of at least a portion of the first VOP for predicting a second VOP that is temporally adjacent to the first VOP. The DMA module is operative: (i) to determine whether the data block is an unrestricted motion vector (UMV) block; (ii) to translate a block address for retrieving at least a portion of the data block from the memory as a function of one or more control parameters generated by the DMA module; and (iii) to generate a completed data block as a function of the at least a portion of the data block retrieved from the memory and the one or more control parameters generated by the DMA module, the second VOP comprising the completed data block.

One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

Techniques of the present invention can provide substantial beneficial technical effects, such as, but not limited to, improving the speed and efficiency of video coding (e.g., video compression, etc.).

These and other features, objects and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals, where used, indicate corresponding elements throughout the several views, and wherein:

FIGS. 1A through 1C conceptually depict an exemplary methodology for generating UMV prediction of a sample image sequence;

FIG. 2 is a conceptual view depicting details of how an illustrative UMV block is constructed;

FIG. 3 is a process flow diagram depicting at least a portion of an illustrative motion estimation methodology;

FIG. 4 is a process flow diagram depicting at least a portion of an exemplary motion estimation methodology, according to an embodiment of the present invention;

FIG. 5 is a block diagram depicting at least a portion of an exemplary motion estimation system in which methods of the invention are implemented, according to an embodiment of the present invention;

FIG. 6 is a block diagram depicting at least a portion of an exemplary DMA module suitable for use in the illustrative motion estimation system shown in FIG. 5, according to an embodiment of the present invention; and

FIG. 7 is a block diagram depicting an exemplary system operative to implement part or all of one or more aspects or processes of the invention, according to an embodiment of the present invention.

### DETAILED DESCRIPTION OF PREFERRED EMBODIMENTS

The present invention, according to aspects thereof, will be described herein in the context of illustrative methods and apparatus for facilitating video coding, more particularly, motion estimation and compensation, using DMA to automatically detect UMV transfers. As used herein, “facilitating” an action is intended to broadly encompass performing the action, making the action easier, helping to carry out the action, or causing the action to be performed. Thus, by way of example and not limitation, instructions executing on one processor might facilitate an action carried out by instructions executing on another (e.g., remote) processor, by sending appropriate data or commands to cause or aid the action to be performed. It should be understood, however, that the present invention is not limited to these or any other particular methods and apparatus. Rather, the invention is more generally applicable to techniques for performing motion estimation and compensation in a manner which simplifies the treatment of motion vectors, reduces cycle count of DMA transfers, and reduces memory bandwidth requirements, among other advantages. Moreover, it will become apparent to those skilled in the art given the teachings herein that numerous modifications can be made to the embodiments shown that are within the scope of the present invention. That is, no limitations with respect to the specific embodiments described herein are intended or should be inferred.

As previously stated, known methodologies for detecting UMVs generally require complex software and additional processing cycles. This is due, at least in part, to conditional change of flow and complex programming of DMA to perform up to four DMA transfers per macroblock, as is required by many video coding standards.

It is well understood that DMA is a system or module that is operative to control a memory system without the necessity of central processing unit (CPU) interaction. On a specified stimulus, the DMA module will move data from one memory location or region to another memory location or region. Although limited in its flexibility, there are many applications in which automated memory access is substantially faster than utilizing the CPU to manage data transfers, particularly for block data transfers. For example, systems like an analog-to-digital converter (ADC) and a digital-to-analog converter (DAC) require frequent and regular transfers of memory into/out of their respective systems. The DMA module can be configured to handle moving the collected data out of a given peripheral module and into more useful memory locations (e.g., arrays). Although generally only memory can be accessed in this manner, most peripheral systems, data registers, and control registers are accessed as if they were memory. The DMA module uses the same memory bus as the CPU and only one or the other can use the memory at the same time.

There are three independent channels for DMA transfers. Each channel preferably receives its trigger for a data transfer through a multiplexer, or alternative selection means, that chooses from among a large number of signals; when the selected signal or signals are asserted, the transfer occurs. A DMA controller receives the trigger signal and handles conflicts for simultaneous triggers. The DMA channel will copy data from a prescribed starting memory location or block to a prescribed destination memory location or block. There are many variations on this, and they are controlled by the DMA Channel x Control Register (DMAxCTL):

Single Transfer—each trigger causes a single transfer. The DMA module will disable itself when a specified number, DMAXSZ, of transfers has occurred; setting DMAXSZ to zero prevents transfer. The DMAxSA and DMAxDA registers set the addresses to be transferred from and to, respectively. The DMAxCTL register also allows these addresses to be incremented or decremented by 1 or 2 bytes with each transfer. This transfer halts the CPU.

Block Transfer—an entire block is transferred on each trigger. The DMA module disables itself when the block transfer is complete. This transfer halts the CPU, and will transfer each memory location one at a time.

Burst-Block Transfer—is very similar to Block Transfer mode, except that the CPU and the DMA transfer can interleave their operations. This reduces the CPU by a certain percentage (e.g., to 20 percent) while the DMA is going on, but the CPU will not be stopped altogether. The interrupt occurs when the block transfer has completed. This mode disables the DMA module when the transfer is complete.

Repeated Single Transfer—the same as Single Transfer mode, except that the module is not disabled when the transfer is complete.

Repeated Block Transfer—the same as Block Transfer mode, except that the module is not disabled when the transfer is complete.

Repeated Burst-Block Transfer—the same as Burst Block Transfer mode, except that the module is not disabled when the transfer is complete.

In accordance with an important aspect of the present invention, a system, or components and/or methodologies thereof, comprises a DMA module adapted to automatically detect UMV transfers. The DMA module according to embodiments of the invention internally duplicates and reuses data for performing optimized memory transfer. In this manner, the system according to embodiments of the invention beneficially simplifies the treatment of UMVs, reduces cycle count of DMA transfers, and reduces required memory bandwidth, among other advantages.

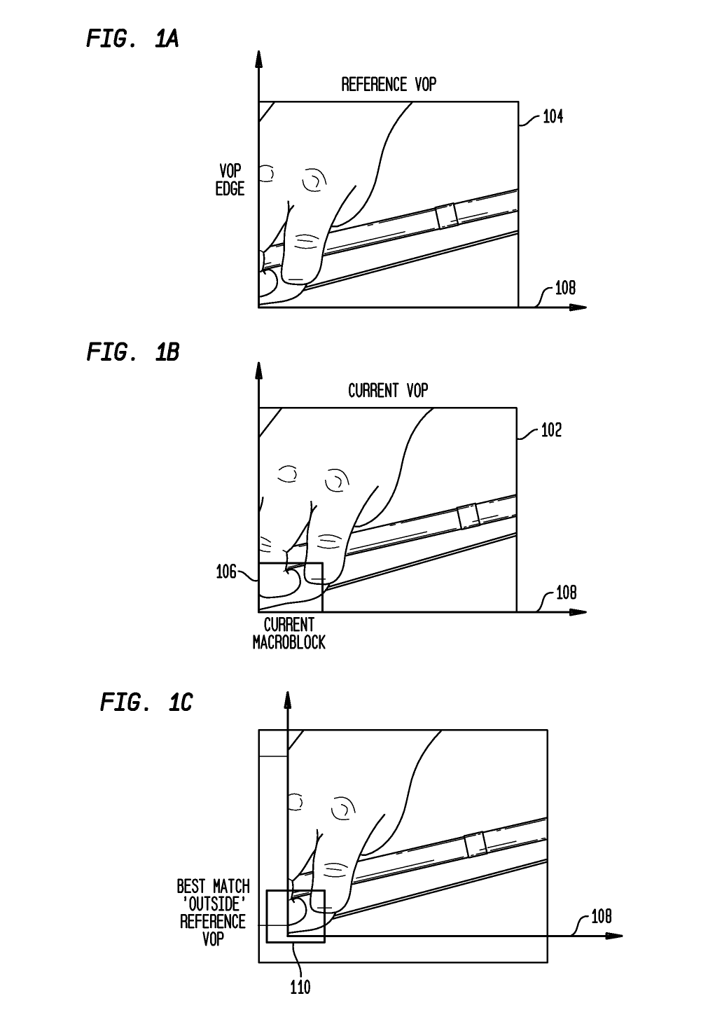

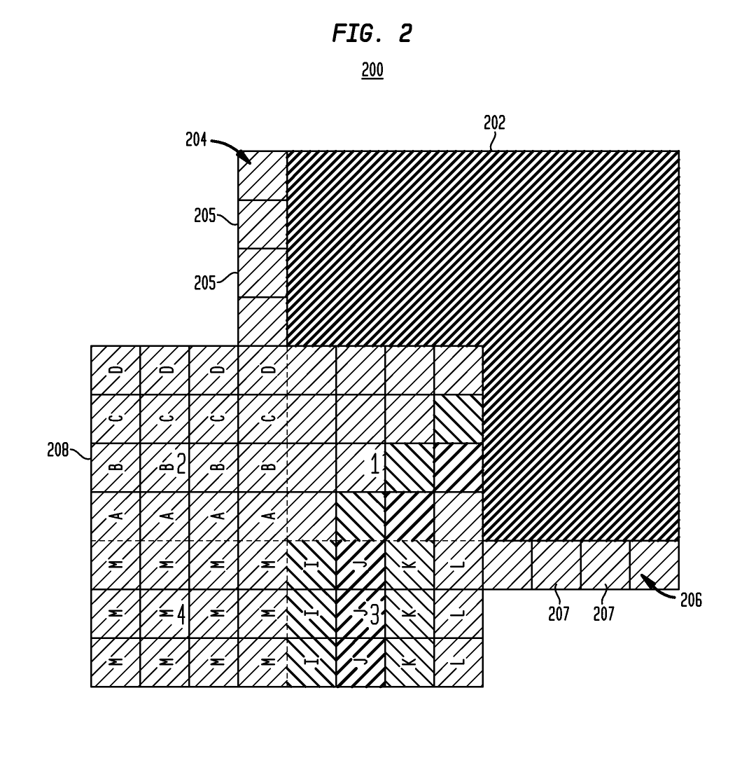

With reference to FIGS. 1A through 1C, an exemplary methodology for generating motion vectors of a sample image sequence is conceptually shown. Specifically, FIG. 1B depicts the lower-left corner of a current VOP 102 and FIG. 1A depicts a temporally previous adjacent VOP, referred to herein as a reference VOP 104. In the images, the hand holding the bow is moving into the picture frame in the current VOP 102, and hence there is not a suitable match for the highlighted macroblock 106 inside the reference VOP 104. Macroblock 106 is bounded on two sides by axes 108.

In FIG. 1C, samples in the reference VOP 104 have been extrapolated (i.e., “padded”) beyond the boundaries (as defined, at least in part, by axes 108) of the reference VOP 104. A better match for the macroblock 106 can be obtained by allowing the motion vector to point into this extrapolated region, i.e., the highlighted macroblock 110. A UMV tool allows motion vectors to point outside the boundaries of the reference VOP 104. If a sample indicated by the motion vector lies outside the reference VOP, the nearest edge sample is preferably used instead.

As previously stated, UMV mode can improve motion compensation efficiency, especially when there are objects moving into and out of a given frame. The process of UMV detection requires complex software and additional clock cycles, which is undesirable. To simplify the treatment of motion vectors, to reduce cycle count of DMA transfers and to reduce memory bandwidth, aspects of the invention advantageously disregard certain cases of UMV and leave this for handling by a DMA module.

According to an embodiment of the invention, a DMA programming model is preferably modified to include one or more quasi-static parameters defining a start point, a horizontal length (i.e., x-length) and a vertical length (i.e., y-length) of a given frame. Additionally, block transfer parameters preferably comprise relative x and y values of a data block start point and x and y lengths of the block being transferred. The DMA module is preferably operative to internally identify the UMVs and to perform up to four transfers per block, as shown conceptually in FIG. 2.

More particularly, by way of illustration only and without loss of generality, FIG. 2 is a conceptual view 200 depicting an exemplary motion estimation methodology in conjunction with a reference VOP 202, according to an embodiment of the invention. VOP 202 is shown having an edge column 204 including a plurality of edge pixels 205 arranged in vertical (e.g., y) direction, and an edge row 206 comprising a plurality of edge pixels 207 arranged in a horizontal (e.g., x) direction. The edge column 204 and edge row 206 define at least a portion of a boundary of the VOP 202.

Also shown in FIG. 2 is a macroblock 208 which, as in the case of FIG. 1C, is defined by allowing the motion vector to point outside the boundary of the reference VOP 202. Macroblock 208 is preferably partitioned into four blocks, labeled 1 through 4, each block defining a subset of pixels corresponding to a prescribed region in the macroblock. It is to be appreciated that the invention is not limited to any particular number of blocks used to partition the macroblock 208, nor is the invention limited to any particular arrangement of blocks within the macroblock.

Specifically, block 1 is comprised of a plurality of pixels within the boundary of VOP 202 and is transferred as is. In this scenario, block 1 contains pels A through M (not their repetitions) since they are inside the frame. Block 2 is comprised of a plurality of pixels based on extrapolated edge column pixels. Block 2 preferably reads from reference frame memory, or an alternative storage means, at least a portion of the edge column 204, namely, pixels A, B, C and D, duplicates these read column edge pixels internally, and writes the pixels a specified number of times (e.g., in this case, four times) to a prescribed destination location. Block 3 is comprised of a plurality of pixels based on extrapolated edge row pixels. Block 3 preferably reads from reference frame memory, or an alternative storage means, at least a portion of the edge row 206, namely, pixels I, J, K and L, duplicates these read row edge pixels internally, and writes the pixels a specified number of times (e.g., four) to a prescribed destination location. Block 4 is comprised of a plurality of pixels based on one corner pixel, pixel M, defining an intersection of the edge column 204 and edge row 206, and is the corner of the frame. In this illustrative scenario, block 4 preferably reads from reference frame memory, or an alternative storage means, the corner pixel M, duplicates this pixel internally, and writes the pixel a specified number of times to a prescribed destination location.

As a result of the above-noted modifications to the DMA transfer, several important benefits are obtained. These benefits include, but are not limited to, reducing the size of software used to perform motion estimation and/or compensation, producing code that is easier to read, elimination, or at least reduction, of conditional branches, reducing the number of cycles required for the processing-intensive task of motion estimation and/or compensation, and decreasing memory bandwidth requirements, e.g., by eliminating memory re-reads of edge column 204 (pixels A through D), edge row 206 (pixels I through L), and edge pixel M in order to write these pixels into blocks 2, 3 and 4, respectively. Since double data rate (DDR) bandwidth is typically a bottleneck in video codecs and DDR response time is typically relatively slow in comparison to other processing paths, techniques according to the invention provide a superior motion estimation and compensation methodology.

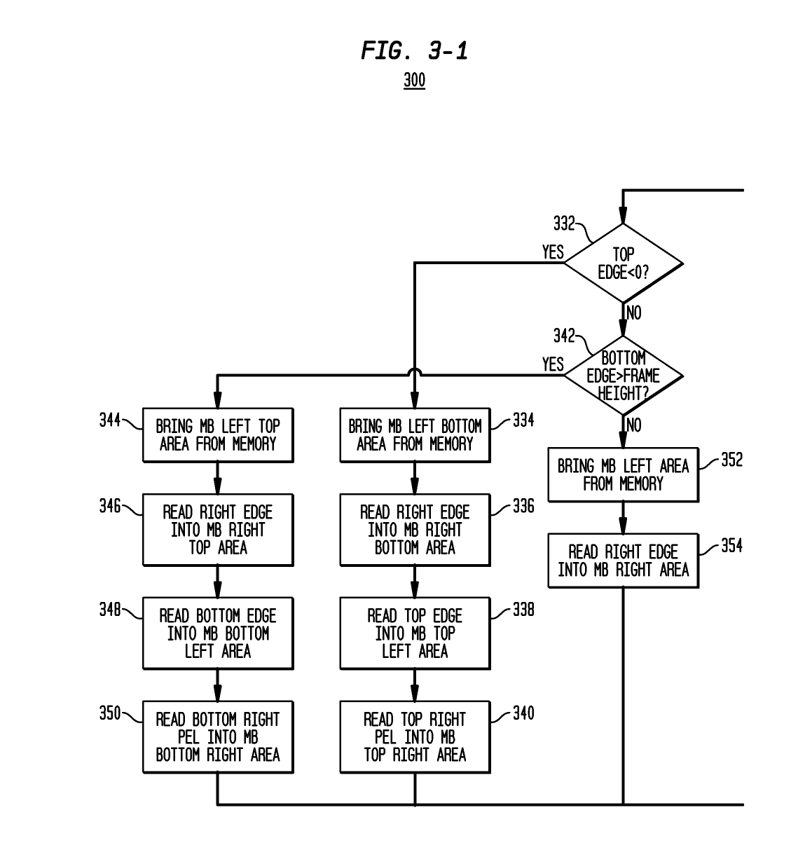

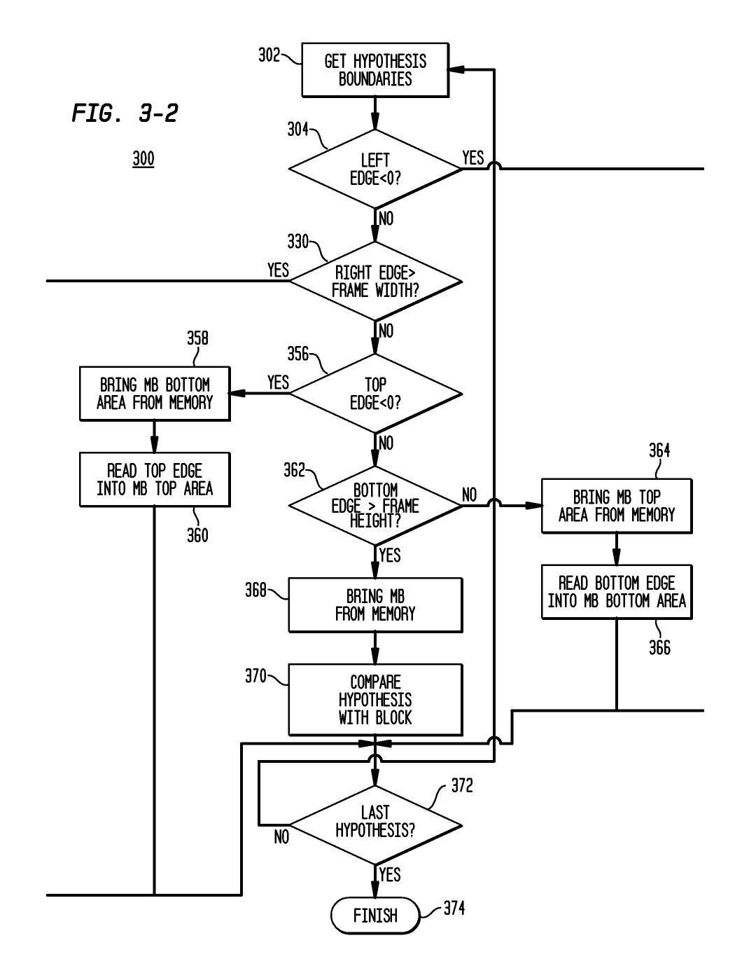

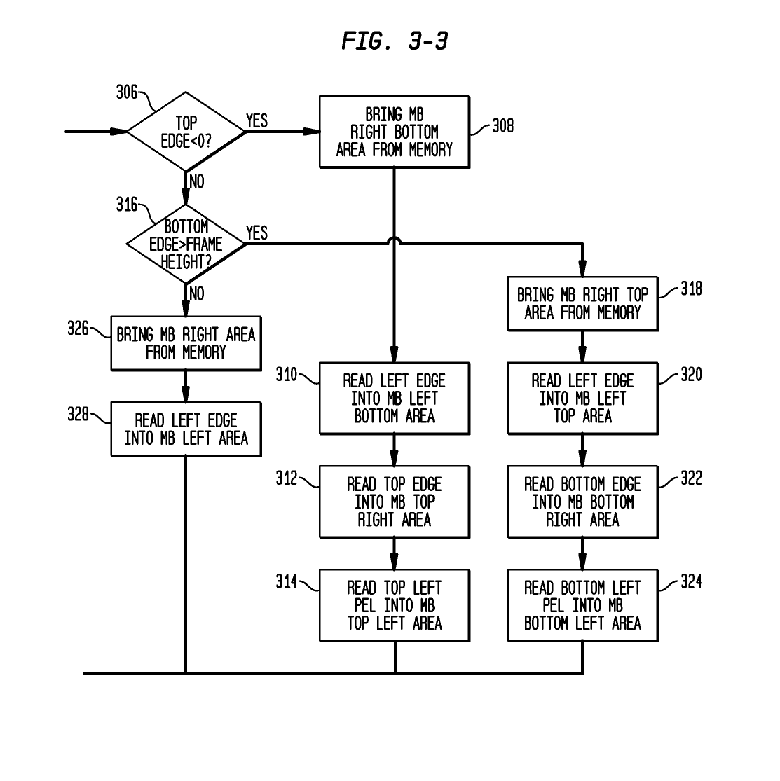

With reference now to FIG. 3, a block diagram depicting at least a portion of an illustrative motion estimation methodology 300 is shown which can be modified to implement techniques of the present invention. Motion estimation method 300 begins by obtaining hypothesis boundaries in step 302. Hypothesis boundaries are parameters used in partitioning a given macroblock (MB) into a plurality of blocks (e.g., four, as in the scenario shown in FIG. 2), each block defining a subset of pixels corresponding to a prescribed region in the macroblock. Thus, each motion vector candidate is a “hypothesis” of the correct motion vector. With each motion vector (hypothesis) there is a predictor macroblock associated therewith, and this macroblock has prescribed boundaries, namely, MaxX, MaxY, MinX, MinY, associated with the right, top, left and bottom edges, respectively, of the reference frame. Using these parameters, boundaries defining an estimated macroblock are tested (also referred to as “hypothesis testing”) to determine whether the motion vectors corresponding to the macroblock lie outside a given reference frame.

More particularly, in step 304, a left edge of the macroblock is preferably checked to determine if its value is less than zero, which is indicative of whether or not the left edge of the macroblock resides outside of the reference frame. If the left edge is less than zero, a top edge of the macroblock is checked in step 306 to determine if its value is less than zero.

As will become apparent to those skilled in the art, each of steps 304 through 374, inclusive, of the exemplary methodology 300 shown in FIG. 3 are further operative to determine whether the macroblock resides outside the reference frame. In particular, steps 304, 306, 316, 330, 332, 342, 356 and 362 are operative to test various locations of the macroblock edges against corresponding reference frame edges, while the remaining steps in methodology 300 act upon the results of these tests to generate a predicted macroblock, as will be described in further detail below. The methodology 300 is preferably adapted to handle all the different types of edges (e.g., right edge, left edge, bottom edge, top edge) by generating copies of the respective edge portions for the missing locations.

Specifically, assuming the top edge of the macroblock is less than zero, as determined in step 306 and the left edge of the macroblock is less than zero, as determined in step 304, a right bottom area of the macroblock is read from memory in step 308, a left edge of the frame is read into a left bottom area of the macroblock in step 310, a top edge of the frame is read into a top right area of the macroblock in step 312, and a top left pel is read into a top left area of the macroblock in step 314. Likewise, when the top edge of the macroblock is not less than zero in step 306 and the left edge of the macroblock is less than zero, as determined in step 304, a bottom edge of the macroblock is checked to determine if it is greater than the reference frame height in step 316.

Assuming the bottom edge of the macroblock is greater than the reference frame height, as determined in step 316, the left edge of the macroblock is less than zero, as determined in step 304, and the top edge of the macroblock is greater than or equal to zero, as determined in step 306, the right top area of the macroblock is read from memory in step 318, the left edge of the frame is read into the left top area of the macroblock in step 320, the bottom edge of the frame is read into the bottom right area of the macroblock in step 322, and a bottom left pel is read into the bottom left area of the macroblock in step 324. Likewise, when the bottom edge of the macroblock is not greater than the reference frame height in step 316 the left edge of the macroblock is less than zero, as determined in step 304, and the top edge of the macroblock is greater than or equal to zero, as determined in step 306, the right area of the macroblock is read from memory in step 326 and the left edge of the frame is read into the left area of the macroblock in step 328.

When the left edge of the macroblock is not less than zero, as determined in step 304, the right edge of the reference frame is checked to determine if it is greater than the frame width in step 330. If the right edge of the reference frame is greater than the frame width, the top edge of the macroblock is checked to determine if it less than zero in step 332. If the top edge of the macroblock is less than zero, the left edge of the macroblock is greater than or equal to zero, as determined in step 304, and the right edge of the macroblock is greater than or equal to the frame width, as determined in step 330, the left bottom area of the macroblock is obtained from memory in step 334, the right edge of the reference frame is read into the right bottom area of the macroblock in step 336, the top edge of the frame is read into the top left area of the macroblock in step 338, and a top right pel is read into the top right area of the macroblock in step 340.

When the top edge of the macroblock is not less than zero, as determined in step 332, the bottom edge of the macroblock is checked to determine if it is greater than the reference frame height in step 342. If the bottom edge of the macroblock is greater than the reference frame height, the left edge of the macroblock is greater than or equal to zero, as determined in step 304, the right edge of the macroblock is greater than the reference frame width, as determined in step 330, and the top edge of the macroblock is greater than or equal to zero, as determined in step 332, the left top area of the macroblock is obtained from memory in step 344, the right edge of the frame is read into the right top area of the macroblock in step 346, the bottom edge of the frame is read into the bottom left area of the macroblock in step 348, and a bottom right pel is read into the bottom right area of the macroblock in step 350. If the bottom edge of the macroblock is greater than the reference frame height, as determined in step 342, the left edge of the macroblock is greater than or equal to zero, as determined in step 304, the right edge of the macroblock is greater than the reference frame width, as determined in step 330, and the top edge of the macroblock is greater than or equal to zero, as determined in step 332, then the left area of the macroblock is obtained from memory in step 354 and the right edge of the reference frame is read into the right area of the macroblock in step 354.

If the right edge of the reference frame is greater than the frame width, as determined in step 330, the top edge of the macroblock is checked to determine if it less than zero in step 356. If the top edge of the macroblock is less than zero, the left edge of the macroblock is greater than or equal to zero, as determined in step 304, and the right edge of the macroblock is less than or equal to the reference frame width, as determined in step 330, then the bottom area of the macroblock is obtained from memory in step 358 and the top edge of the frame is read into the top area of the macroblock in step 360. If the top edge of the macroblock is not less than zero, as determined in step 356, the left edge of the macroblock is greater than or equal to zero, as determined in step 304, and the right edge of the macroblock is less than or equal to the reference frame width, as determined in step 330, then the bottom edge of the macroblock is checked to determine if it is greater than the frame height in step 362.

Assuming the bottom edge of the macroblock is not greater than the frame height, the left edge of the macroblock is greater than or equal to zero, as determined in step 304, the right edge of the macroblock is less than or equal to the frame width, as determined in step 330, and the top edge of the macroblock is less than zero, as determined in step 356, then the top area of the macroblock is obtained from memory in step 364 and the bottom edge of the frame is read into the bottom area of the macroblock in step 366. Alternatively, if the bottom edge of the macroblock is not greater than the frame height, as determined in step 362, the left edge of the macroblock is greater than or equal to zero, as determined in step 304, the right edge of the macroblock is less than or equal to the frame width, as determined in step 330, and the top edge of the macroblock is less than zero, as determined in step 356, the macroblock is obtained from memory in step 368 and the macroblock is then compared with the hypothesis in step 370.

After obtaining the respective results in steps 314, 324, 328, 340, 350, 354, 360 and 370, the motion estimation methodology 300 preferably checks to determine if the current hypothesis is the last hypothesis in step 372. When it is determined that the last hypothesis has been processed, the method ends at step 374. Otherwise, process flow continues at step 302, wherein the next set of hypothesis boundaries is obtained.

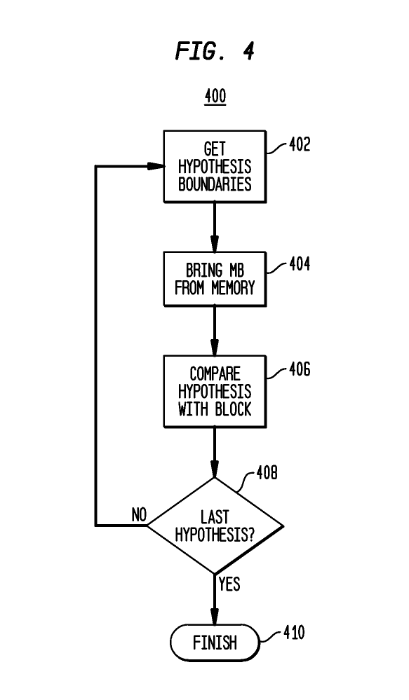

Unfortunately, the motion estimation methodology 300 depicted in FIG. 3, due at least in part to its widespread use of conditional branching (e.g., as evidenced by steps 304, 306, 316, 330, 332, 342, 356, 362 and 372), consumes a significant amount of processing cycles, in addition to other timing and control resources. FIG. 4 is a block diagram depicting at least a portion of an exemplary motion estimation methodology 400, according to an embodiment of the invention. Motion estimation methodology 400, by utilizing block DMA transfers in accordance with aspects of the invention, is considerably more efficient, at least in terms of memory resources, and thus more advantageous compared to the motion estimation method 300 shown in FIG. 3.

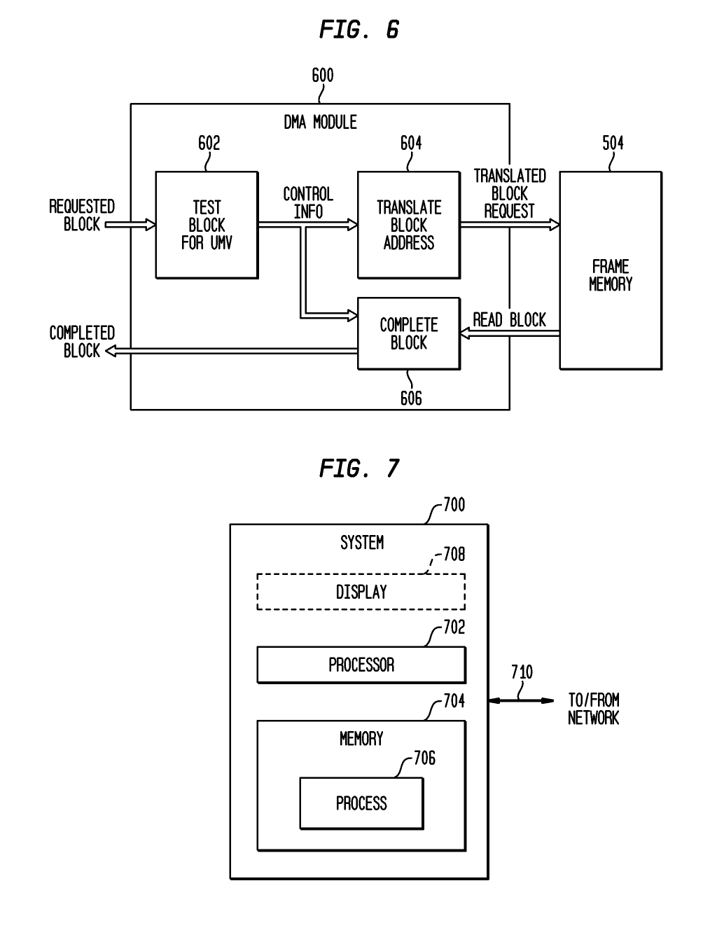

As will become apparent to those skilled in the art, FIG. 4 shows an illustrative process flow diagram for the UMV motion estimation methodology 400 as may be implemented by a processor or alternative circuitry according to aspects of the invention. It is to be understood, however, that the motion estimation methodology 400 is merely a basic implementation of the inventive techniques and does not necessarily comprise the entire set of operations that may be performed, for example, internally by the illustrative circuit implementation shown in FIG. 6, which will be described in further detail below. This is due, at least in part, to the fact that the processor simply requests the motion vector block prediction and the internal circuit performs the complex operations shown in FIG. 3 and returns a correct prediction block. This frees up the processor to perform other tasks.

With reference to FIG. 4, motion estimation method 400 preferably begins in step 402 by obtaining hypothesis boundaries corresponding to a given macroblock. Once the hypothesis boundaries for the macroblock have been obtained, a request is sent by a processor to read a block (e.g., macroblock or sub-block—an AVC algorithm enables dividing the macroblock into smaller sub-blocks, for example four 8×8 blocks, and searching for a separate motion vector for each sub-block) from a frame memory in step 404. In step 406, a comparison is performed to determine whether any portion of the requested block defined by a hypothesis boundary resides in the frame memory. If the DMA module identifies the requested block as a UMV block, the DMA module translates the read to the memory (e.g., frame memory) for the portion of the block that resides in memory, without the need for intervention by the processor. In step 408, the method checks to see whether or not the current motion vector hypothesis (which corresponds to boundaries and block predictor) is the last hypothesis to be processed. If not, the method control returns to step 402 where a new set of hypothesis boundaries corresponding to a next hypothesis is obtained. If step 408 determines that all hypotheses have been processed, the method 400 ends at step 410.

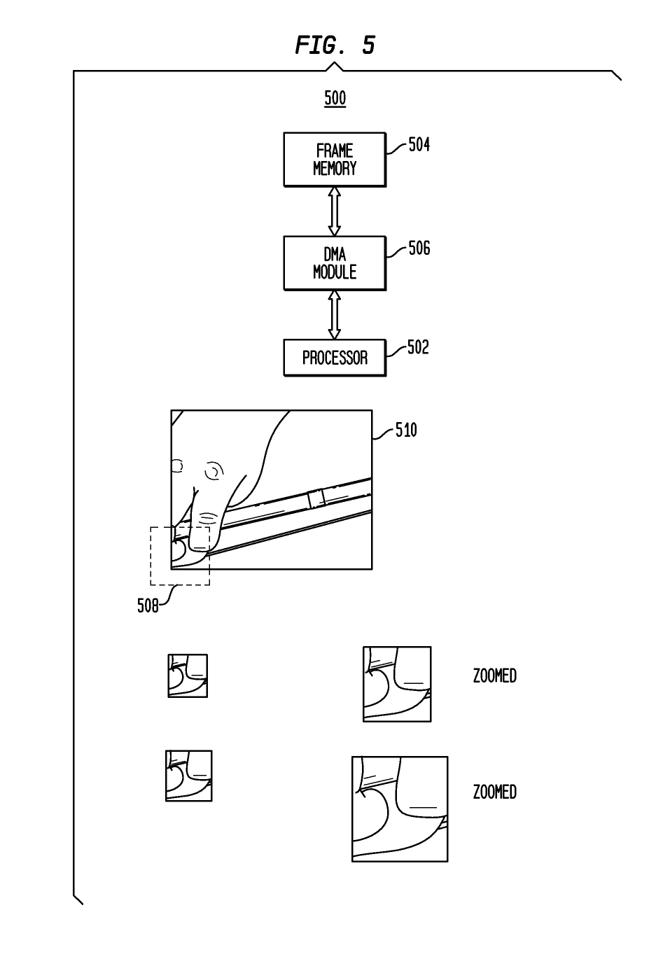

FIG. 5 is a block diagram depicting at least a portion of an exemplary motion estimation system 500 in which methods of the invention are implemented, according to an embodiment of the invention. Motion estimation system 500 comprises a processor 502 operative to perform techniques of the invention, a frame memory 504, and a DMA module coupled with the processor and the frame memory.

In terms of operation, processor 502 preferably requests to read a block, such as block 508 indicative of a motion predictor, from the frame memory 504 via the DMA module 506 using the inventive methodology previously described. A reference VOP 510 is preferably stored in the frame memory 504. The DMA module 506 is operative to identify the requested block as a UMV block and translates the read to an appropriate area of the frame memory for the portion of the block that resides in the frame memory. To accomplish this, the DMA module 506 is preferably operative to determine, as a function of prescribed hypothesis boundaries, which portions of the requested block 508 reside in the frame memory 504 (e.g., reference VOP 510) and which portions of the requested block do not reside in the frame memory. In the illustrative embodiment shown, a single DMA transform is performed, whereby the portion of the requested block determined to reside in the frame memory 504 is retrieved from the memory and the remaining portions of the block are then interpolated, by the DMA module 506, to generate the entire block predictor.

FIG. 6 is a block diagram depicting at least a portion of an exemplary DMA module 600 suitable for use in the motion estimation system 500 shown in FIG. 5, according to an embodiment of the invention. As shown in FIG. 6, DMA module 600 preferably includes a first processing module 602 operative to receive (e.g., from processor 502 in FIG. 5) a request to read a block, referred to herein as a requested block, and to test the block (e.g., using hypothesis testing, as previously described, or using an alternative boundary checking methodology) to determine whether or not the requested block is a UMV block. Module 602 preferably tests for a UMV block in a manner consistent with the tests performed in FIG. 3. Specifically, module 602 preferably compares the edges of the macroblock with corresponding edges of the frame. Once the requested block is determined to be a UMV block, control parameters, which may include, for example, block address, block length, etc., are supplied concurrently to second and third processing modules, 604 and 606, respectively. Without limitation, such control parameters supplied to the second and third processing modules 604, 606 may include, for example, the four areas of the macroblock (e.g., left, right, top, and bottom) and what memory transfers comprise them.

For the portion of the requested block that is determined to reside in frame memory 504, first processing module 602 is operative to supply at least a block address to the second processing module 604. Second processing module 604 is preferably operative to generate a translated block request as a function of a corresponding first set of control parameters, which may include at least the block address, received from the first processing module 602. The translated block request is then sent to the frame memory 504 for retrieving the portion of the requested block residing therein.

For the portion of the requested block that is determined not to reside in the frame memory 504, a corresponding second set of control parameters are supplied to the third processing module 606, preferably concurrently with the first set of control parameters sent to the second processing module, for interpolating missing portions of the requested block. The control parameters sent to block 604 used to translate the block address are preferably the same as those sent to block 606 used to generate the complete block, although such arrangement is not a requirement. In this regard, the third processing module 606 is operative to receive, from the frame memory 504, the block read therefrom based on the translated block request. The third processing module 606 is further operative to interpolate the remaining portions of the requested block not residing in the frame memory as a function of the read block and the second set of control parameters received from the first processing module 602 to thereby generate the completed predictor block. The completed block is then sent to the processor and/or an alternative system component to satisfy the initial request.

At least a portion of the techniques of the present invention may be implemented in an integrated circuit. In forming integrated circuits, identical die are typically fabricated in a repeated pattern on a surface of a semiconductor wafer. Each die includes a device described herein, and may include other structures and/or circuits. The individual die are cut or diced from the wafer, then packaged as an integrated circuit. One skilled in the art would know how to dice wafers and package die to produce integrated circuits. Any of the exemplary circuits illustrated in FIGS. 1 through 3, or portions thereof, may be part of an integrated circuit. Integrated circuits so manufactured are considered part of this invention.

An integrated circuit in accordance with the present invention can be employed in essentially any application and/or electronic system in which video coding (e.g., video compression, video decompression, etc.) is utilized. Suitable systems for implementing techniques of the invention may include, but are not limited to, image processors, interface devices (e.g., interface networks, high-speed memory interfaces (e.g., DDR3, DDR4), etc.), personal computers, communication networks, etc. Systems incorporating such integrated circuits are considered part of this invention. Given the teachings of the invention provided herein, one of ordinary skill in the art will be able to contemplate other implementations and applications of the techniques of the invention.

### System and Article of Manufacture Details

The invention can employ hardware or hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a tangible computer-readable recordable storage medium (or multiple such media). Appropriate interconnections via bus, network, and the like can also be included.

FIG. 7 is a block diagram depicting an exemplary system operative to implement part or all of one or more aspects or processes of the invention, according to an embodiment of the present invention. The system 700 includes a processor 702 which is preferably representative of processors (e.g., processor 502 shown in FIG. 5) which may be associated with, for example, servers, clients, set top terminals, and other elements with processing capability depicted in the other figures. In one or more embodiments, inventive steps are carried out by one or more of the processors, either alone or in conjunction with one or more interconnecting network(s).

As shown in FIG. 7, memory 704 configures the processor 702 to implement one or more aspects of the methods, steps, and functions disclosed herein (collectively, shown as process 706 in FIG. 7). Memory 704 may also comprise the frame memory (e.g., frame memory 504 shown in FIGS. 5 and 6). The memory 704 could be distributed or local and the processor 702 could be distributed or singular. The memory 704 could be implemented as an electrical, magnetic or optical memory, or any combination of these or other types of storage devices. It should be noted that if distributed processors are employed, each distributed processor that makes up processor 702 generally contains its own addressable memory space. It should also be noted that some or all of computer system 700 can be incorporated into an application-specific or general-use integrated circuit. For example, one or more method steps could be implemented in hardware in an ASIC rather than using firmware. Display 708 is representative of a variety of possible input/output devices (e.g., mice, keyboards, printers, etc.).

As is known in the art, part or all of one or more aspects of the methods and apparatus discussed herein may be distributed as an article of manufacture that itself includes a computer readable medium having non-transient computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store, in a non-transitory manner, information suitable for use with a computer system may be used. The computer-readable code means is intended to encompass any mechanism for allowing a computer to read instructions and data, such as magnetic variations on a magnetic medium or height variations on the surface of a compact disk. As used herein, a tangible computer-readable recordable storage medium is intended to encompass a recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, e.g., by processing capability on individual elements in the other figures, or by any combination thereof. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention can make use of computer technology with appropriate instructions to implement the methodologies described herein.

As used herein, a “server” includes a physical data processing system (for example, system 700 as shown in FIG. 7) running a server program. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can reside on the same medium, or each module can reside on a different medium, for example. The modules can include any or all of the components shown in the figures (e.g., DMA module 506 shown in FIGS. 5 and 6, and any sub-modules therein). Methodologies according to embodiments of the invention can then be carried out using the distinct software modules of the system, as described above, executing on the one or more hardware processors (e.g., a processor or processors in the motion estimation system). Further, a computer program product can include a tangible computer-readable recordable storage medium with code adapted to be executed to carry out one or more steps of the illustrative methodologies described herein, including the provision of the system with the distinct software modules.

Non-limiting examples of languages that may be used include markup languages (e.g., hypertext markup language (HTML), extensible markup language (XML), standard generalized markup language (SGML), and the like), C/C++, assembly language, Pascal, Java, and the like.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

System(s) have been described herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors such as video processors, digital signal processors (DSPs), etc. Thus, for example, DMA module 506 (or any other blocks, components, sub-blocks, sub-components, modules and/or sub-modules) may be realized by one or more video processors. A video processor may comprises a combination of digital logic devices and other components, which may be a state machine or implemented with a dedicated microprocessor (e.g., CPU) or micro-controller running a software program or having functions programmed in firmware.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method for performing motion estimation based on at least a first video object plane (VOP) stored in a memory, the method comprising the steps of:
receiving a request to read a data block indicative of at least a portion of the first VOP for predicting a second VOP that is temporally adjacent to the first VOP;
utilizing a direct memory access (DMA) module for determining whether the data block is an unrestricted motion vector (UMV) block;
translating a block address for retrieving at least a portion of the data block from the memory as a function of one or more control parameters generated by the DMA module; and
generating a completed data block as a function of the at least a portion of the data block retrieved from the memory and the one or more control parameters generated by the DMA module, the second VOP comprising the completed data block;
wherein each of the steps is performed by at least one processor.

2. The method of claim 1, wherein the UMV block comprises a macroblock residing at least partially outside of prescribed boundaries corresponding to a reference frame.

3. The method of claim 1, wherein determining whether the data block is a UMV block comprises performing at least one of hypothesis testing and boundary checking on the data block.

4. The method of claim 1, wherein the step of utilizing the DMA module for determining whether the data block is a UMV block comprises:
dividing the data block into a plurality of macroblocks;
comparing one or more edges of a given one of the macroblocks with corresponding one or more edges of a reference frame; and
generating one or more control parameters indicative of whether the given macroblock resides within the reference frame.

5. The method of claim 1, wherein the step of generating the complete data block comprises:
receiving at least a portion of the data block retrieved from the memory based on a first subset of the control parameters indicative of a translated block address; and
interpolating remaining portions of the data block not residing in memory as a function of the at least a portion of the data block retrieved from the memory and a second subset of the control parameters indicative of whether the data block is a UMV block to thereby generate the completed data block.

6. The method of claim 5, wherein the first and second subset of control parameters are the same.

7. The method of claim 1, wherein the one or more control parameters comprises at least one of block address and block length corresponding to the data block.

8. The method of claim 1, further comprising receiving hypothesis boundaries corresponding to a given macroblock, wherein determining whether the data block is a UMV block comprises comparing the data block with the hypothesis boundaries and generating an output indicative of the data block comprising a UMV block when at least a portion of the data block resides within the hypothesis boundaries.

9. The method of claim 8, further comprising:
checking to determine whether a current motion vector hypothesis corresponding to a current set of hypothesis boundaries and a current block predictor is a last hypothesis to be processed;
when the current block predictor is not the last hypothesis to be processed, receiving a new set of hypothesis boundaries corresponding to a new macroblock and determining whether at least a portion of the new macroblock resides within the new set of hypothesis boundaries; and
when the current block predictor is the last hypothesis to be processed, returning the completed data block.

10. An apparatus for performing motion estimation based on at least a first video object plane (VOP), the apparatus comprising:
memory adapted to store at least the first VOP;
a direct memory access (DMA) module coupled with the memory; and
at least one processor coupled with the DMA module, the at least one processor being operative to generate a request to read a data block indicative of at least a portion of the first VOP for predicting a second VOP that is temporally adjacent to the first VOP;
wherein the DMA module is operative: (i) to determine whether the data block is an unrestricted motion vector (UMV) block; (ii) to translate a block address for retrieving at least a portion of the data block from the memory as a function of one or more control parameters generated by the DMA module; and (iii) to generate a completed data block as a function of the at least a portion of the data block retrieved from the memory and the one or more control parameters generated by the DMA module, the second VOP comprising the completed data block.

11. The apparatus of claim 10, wherein the memory comprises a frame memory.

12. The apparatus of claim 10, wherein the DMA module comprises:
a first processing module operative to receive the request to read the data block, to determine whether the requested block is a UMV block, and to generate at least first and second subsets of control parameters indicative of whether at least a portion of the block resides in the memory;
a second processing module operative to receive the first subset of control parameters and to generate a translated block request as a function of the first subset of control parameters for retrieving the portion of the data block residing in the memory; and
a third processing module operative to receive the second subset of control parameters and to generate the completed data block as a function of the at least a portion of the requested data block retrieved from the memory and the second subset of control parameters, the second VOP comprising the completed data block.

13. The apparatus of claim 12, wherein the first and second subsets of control parameters are the same.

14. The apparatus of claim 12, wherein at least one of the first and second subsets of control parameters comprises at least one of a block address and a block length.

15. The apparatus of claim 12, wherein the third processing module is further operative to interpolate missing portions of the requested block not residing in the memory as a function of the second subset of control parameters.

16. The apparatus of claim 12, wherein the first processing module is operative to determine whether the requested block is a UMV block by performing hypothesis testing, whereby one or more edges of a macroblock associated with the requested data block is compared with corresponding one or more edges of a reference frame.

17. The apparatus of claim 12, wherein, for a portion of the requested block determined to reside in the memory, the first processing module is operative to generate the first subset of control parameters comprising at least a block address corresponding to the portion of the requested block residing in the memory, and for a portion of the requested block determined to reside outside of the memory, the first processing module is operative to generate the second subset of control parameters for causing the third processing module to interpolate missing portions of the requested block not residing in the memory as a function thereof.

18. An integrated circuit comprising at least one apparatus for performing motion estimation based on at least a first video object plane (VOP), the at least one apparatus comprising:
memory adapted to store at least the first VOP;
a direct memory access (DMA) module coupled with the memory; and
at least one processor coupled with the DMA module, the at least one processor being operative to generate a request to read a data block indicative of at least a portion of the first VOP for predicting a second VOP that is temporally adjacent to the first VOP;
wherein the DMA module is operative: (i) to determine whether the data block is an unrestricted motion vector (UMV) block; (ii) to translate a block address for retrieving at least a portion of the data block from the memory as a function of one or more control parameters generated by the DMA module; and (iii) to generate a completed data block as a function of the at least a portion of the data block retrieved from the memory and the one or more control parameters generated by the DMA module, the second VOP comprising the completed data block.

19. The integrated circuit of claim 18, wherein the DMA module comprises:
a first processing module operative to receive the request to read the data block, to determine whether the requested block is a UMV block, and to generate at least first and second subsets of control parameters indicative of whether at least a portion of the block resides in the memory;
a second processing module operative to receive the first subset of control parameters and to generate a translated block request as a function of the first subset of control parameters for retrieving the portion of the data block residing in the memory; and
a third processing module operative to receive the second subset of control parameters and to generate the completed data block as a function of the at least a portion of the requested data block retrieved from the memory and the second subset of control parameters, the second VOP comprising the completed data block.

20. The integrated circuit of claim 19, wherein, for a portion of the requested block determined to reside in the memory, the first processing module is operative to generate the first subset of control parameters comprising at least a block address corresponding to the portion of the requested block residing in the memory, and for a portion of the requested block determined to reside outside of the memory, the first processing module is operative to generate the second subset of control parameters for causing the third processing module to interpolate missing portions of the requested block not residing in the memory as a function thereof.

21. An article of manufacture comprising a computer usable medium having a non-transitory computer readable program code embodied therein, said computer readable program code adapted to be executed to implement a method for performing motion estimation based on at least a first video object plane (VOP) stored in a memory, the method comprising the steps of:
receiving a request to read a data block indicative of at least a portion of the first VOP for predicting a second VOP that is temporally adjacent to the first VOP;
utilizing a direct memory access (DMA) module for determining whether the data block is an unrestricted motion vector (UMV) block;
translating a block address for retrieving at least a portion of the data block from the memory as a function of one or more control parameters generated by the DMA module; and
generating a completed data block as a function of the at least a portion of the data block retrieved from the memory and the one or more control parameters generated by the DMA module, the second VOP comprising the completed data block.
